(19) United States
(12) Patent Application Publication
(10) Pub. No.: US 2018/0086245 A1
(43) Pub. Date: Mar. 29, 2018

(54) Hinged Baffle Transport Trailer Container

(71) Applicant: Recover Energy Services Inc., Calgary (CA)

(72) Inventor: Cory Heck, Calgary (CA)

(21) Appl. No.: 15/715,643

(22) Filed: Sep. 26, 2017

Related U.S. Application Data
(60) Provisional application No. 62/401,660, filed on Sep. 29, 2016.

(51) Int. Cl. B60P 1/28; B65D 88/12; B65D 88/56; B65D 90/00

(52) U.S. Cl. CPC B60P 1/286; B65D 88/129; B65D 90/008; B65D 90/0066; B65D 88/56

(57) ABSTRACT

A transport container configured for use with a dump truck tractor trailer. The container comprises: a) a pivotable lid configured to cover and expose an open top of the container, the open top allowing addition of contents to the container; b) a pivotable end gate configured to cover and expose an open back end of the container, the open back end allowing dumping of contents of the container; and c) at least one baffle inside the container, the baffle pivotably connected to opposing sidewalls of the container and forming a substantially vertical barrier preventing substantial movement of contents of the container past the baffle during dumping and transport when locked in a substantially vertical position by an operator-controlled retention mechanism operatively connected between the baffle and at least one of the opposing sidewalls of the container.

### CROSS-REFERENCE TO RELATED APPLICATIONS

This application claims priority to U.S. Provisional Patent Application No. 62/401,660, filed on, Sep. 29, 2016, the entire disclosure of which is incorporated herein by reference in its entirety.

### FIELD OF THE INVENTION

The invention relates to a container for use on a transport trailer for the transportation of a fluid mixture such as an industrial slurry, where containment and general prevention of movement of the fluid mixture during transport is required.

### BACKGROUND

Two commonly used motor vehicles for transporting loads on roadways are tractor trailers and tank trucks or “tankers.” Tractor trailers typically comprise a towing vehicle, commonly referred to as the tractor or the truck, and one or more semi-trailers for carrying cargo. The semi-trailer is attached to the tractor at a point just forward of the rear-most axle of the tractor such that a fraction of the weight of the trailer is carried by the tractor.

Tankers are primarily used to carry various liquid or semi-liquid cargoes. A tanker typically comprises a sealed cylindrical tank lying horizontally on a truck bed and often includes an integral pumping system for pumping material in and out of the tank. Large tankers can have a capacity ranging from 21,000 to 44,000 L (5,500 to 11,600 US gallons), while small tankers have a capacity less than 11,000 L (3,000 US gallons). Tankers may include additional features such as insulation, pressurization, and/or compartmentalization, depending on the cargoes being carried. Due to the cylindrical shape, a tanker has a high center of gravity which makes it more difficult to drive than a tractor trailer.

For transporting various fluid materials, including mixtures of liquids and solids like a sludge or slurry, both tractor trailers and tankers can be used. A vacuum tanker is a specific type of tanker that is typically used for transporting sludge and slurries such as drilling muds, drill cuttings and cement from oil and gas well sites, as well as sewage and waste from cleaning streets, sewers, septic tanks and grease bins. A vacuum tanker uses a heavy duty vacuum system for pneumatically loading and unloading material into and out of the tank through suction lines. While vacuum tankers can be effective for transporting slurries/sludge, they are generally more expensive than tractor trailers and the inside of the tank can be difficult to access for cleaning and maintenance purposes. As such, dump truck tractor trailers having a container on the trailer are often used for transporting a sludge/slurry.

Using a dump truck tractor trailer allows a sludge/slurry in the container to be quickly and easily unloaded, as one side or end of the container can lift up and a gate opens on the opposite side or end to allow the sludge/slurry to flow out of the container through the gate. Using an open top container dump truck allows a sludge/slurry to easily be loaded into the container using an auger and allows easy access to the container for cleaning and maintenance purposes. However, the sludge/slurry can slosh around in the container and spill over the sides of the container during transport. Using a closed container can help keep the sludge/slurry in the container, however a closed container is more difficult to load and clean. Furthermore, the sludge/slurry can still slosh around in the container during transport, making it difficult for the driver to handle the truck under various driving conditions. The slurry/sludge may also accumulate at one end of the truck when the driver accelerates or decelerates, or when the truck is driving up or down a hill. This is especially problematic driving uphill, as the slurry/sludge may amass at the rear end of the container, moving the center of gravity of the load to the rear of the trailer and removing the load from the truck drive axles that are located near the front of the trailer, causing the truck to be unable to drive up the hill. This is especially problematic at oil or gas extraction sites where steep hills and rough roads are often encountered.

A review of the prior art reveals several patents related to various style transport trucks and tankers.

U.S. Pat. No. 4,389,314, incorporated herein by reference in its entirety, describes a flush tank end-dump style eductor truck adapted to siphon debris from a sewer/catch basin. The truck includes a settling tank having a series of vertical hinged internal baffles dividing the tank into sections and a hinged rear door. When a mixture of debris and liquid is siphoned into the rear-most section of the settling tank, the heavier debris falls to the floor and the fluid is distributed through all the settling tank sections by flowing through large openings in the internal baffles. The baffle near the front end of the tank includes small openings to strain out the fine debris from the fluid as it flows into the front-end compartment. This strained fluid can then be re-used to further flush out the sewer/catch basin. When the settling tank is to be emptied, the tank is pivoted upwardly by a hydraulic cylinder and the rear door and internal baffles swing open around upper pivots to permit debris to be cleaned out. The rear door contains a hydraulically-activated latch mechanism to prevent the door from opening until the tank is in a full upward tilt position.

U.S. Pat. No. 4,136,973, incorporated herein by reference in its entirety, describes a cylindrical transport tank for transporting a mixture of manure and water having guide members to produce recirculating and swirling motions of the mixture within the tank as the result of normal movements of the tank during transportation. A first guide member is inclined upwardly from the rear of the tank to the front of the tank, curving downwards at the front, to cause the mixture to surge forward up the guide member during stopping motions. A second guide member extends from the top of the tank downwardly at an inclination opposite the first guide member to prevent the mixture from sloshing backwards to the rear of the tank after it has surged forward. The rearmost portion of the first guide member is hinged, thereby allowing the returning mixture to rotate this portion of the first guide upwardly and flow toward a rear discharge valve.

U.S. Pat. No. 6,547,091, incorporated herein by reference in its entirety, describes a water tanker having internal baffles for preventing surging of the water during transportation. The internal baffles are configured to allow maintenance access between compartments defined by the baffles Specifically, there are lateral baffle doors along the interior sides of the tanker that open and close like a door from a lateral direction to a longitudinal direction, such that when all the doors are in an open longitudinal direction, workers have unobstructed access to the side sections of the tanker from the front end to the rear end.

U.S. Pat. No. 4,775,070, incorporated herein by reference in its entirety, describes an internal baffle system for a tank to prevent fluid surges. Specifically, the interior of the tank is divided into upper and lower compartments by a plurality of upper stationary vertical baffles extending downward from the top interior wall of the tank to a middle point within the tank, and a plurality of lower stationary vertical baffles extending upward from the bottom interior floor of the tank to the middle point. A rotatable member is positioned in the middle of the tank between the upper and lower baffles and is moveable between an open and closed position to either allow or block fluid from flowing between the upper and lower compartment.

U.S. Pat. No. 4,251,005, incorporated herein by reference in its entirety, describes a tank for transporting liquids having a baffle system to control liquid surges. The baffle system includes large longitudinal cylindrical hollow baffles extending the length of the tank and transverse support partitions extending between the side walls of the tank.

U.S. Pat. No. 2,552,119, incorporated herein by reference in its entirety, describes a collapsible fuel tank for an aircraft having “cross elements” or baffles positioned transversely in the interior of the tank and spaced apart longitudinally from the front to the rear of the tank to provide internal support. The baffles are generally circular in shape and have a vertically positioned hinge in the middle of the baffle to allow the baffle to fold in half when the fuel tank is collapsed.

U.S. Pat. No. 3,905,308, incorporated herein by reference in its entirety, describes a railway car having a built-in swimming pool containing moveable vertical hinged, baffles that operate automatically to contain the water when the train accelerates, decelerates or stops. The baffles are hinged to a side wall of the train, and lie relatively flat against the wall in the retracted position. The baffles are actuated automatically when the braking system of the train is applied, swinging outwardly from the side wall to extend transversely towards the opposite side wall, extending across the pool to inhibit forward or rearward displacement of the water.

U.S. Pat. No. 4,331,342, incorporated herein by reference in its entirety, describes a tank wagon for liquid material having internal partitions with dampeners that divide the tank into compartments and counteract movement of the liquid material with respect to the tank in one direction only: from the rear to the front of the tank. The internal vertical partitions extend between the side walls of the tank, leaving an opening between the bottom edge of the partition and the tank floor. The bottom section of the partition has a flap that rests in an open position and allows fluid movement at the bottom of the tank when the tank is at a constant speed or accelerating. When the tank decelerates and fluid is thrust towards the front of the tank, the fluid pushes the flap into a closed position to limit fluid movement towards the front of the tank.

Commonly owned U.S. Pat. No. 9,061,623, incorporated herein by reference in its entirety, describes a sealable transport trailer container with hinged baffles for transporting unstabilized drill cuttings which are highly fluidic in nature.

There continues to be a need for improvements in containers used for transporting and dumping wet fluidic drilling waste or dry solid drilling waste.

### SUMMARY OF THE INVENTION

In accordance with one embodiment of the invention, there is provided a transport container configured for use with a dump truck tractor trailer, the container comprising: a pivotable lid configured to cover and expose an open top of the container, the open top allowing addition of contents to the container; a pivotable end gate configured to cover and expose an open back end of the container, the open back end allowing dumping of the contents; and at least one baffle inside the container, the baffle pivotably connected to opposing sidewalls of the container and forming a substantially vertical barrier preventing substantial movement of the contents past the baffle during dumping and transport when locked in a substantially vertical position by an operator-controlled retention mechanism operatively connected between the baffle and at least one of the opposing sidewalls of the container.

In certain embodiments, the retention mechanism operatively engages the baffle to at least one of the opposing sidewalls.

In certain embodiments, the bottom of the baffle is held above the floor of the container when in the substantially vertical position, leaving a gap between the bottom of the baffle and the floor of the container.

In certain embodiments, the baffle is hinged to the opposing sidewalls at a position substantially adjacent to the top end of the baffle.

In certain embodiments, the retention mechanism is a pin inserted into an outer sidewall opening and extending therethrough into an opening in the baffle, thereby locking the baffle in place in the substantially vertical position.

In certain embodiments, the transport container further comprises an operator-controlled guide mechanism for aligning the outer sidewall opening and the opening in the baffle, to facilitate insertion of the pin.

In certain embodiments, the guide mechanism comprises a rotatable rod extending from the front of the container to the baffle, wherein one end of the rod is attached to a pair of parallel baffle guide arms which engage the baffle at opposite sides from the top end of the baffle.

In certain embodiments, the guide arms have lengths ranging from about one third to about two thirds of the height of the baffle.

In certain embodiments, the baffle is hinged to the opposing sidewalls at an intermediate position between the top of the baffle and the bottom of the baffle.

In certain embodiments, the retention mechanism is a hydraulic ram operatively connected between at least one of the opposing sidewalls and an upper part of the baffle above the hinge, the hydraulic ram configured to: pivot the baffle away from the substantially vertical position when the hydraulic ram is extending; pivot the baffle toward the substantially vertical position when the hydraulic ram is retracting; and retain the baffle in place when the hydraulic ram is stationary.

In accordance with another embodiment of the invention, there is provided a transport container configured for use with a dump truck tractor trailer, the container comprising: a pivotable lid configured to cover and expose an open top of the container, the open top allowing addition of contents to the container; a pivotable end gate configured to cover and expose an open back end of the container, the open back end allowing dumping of contents of the container; and at least one baffle inside the container, the baffle pivotably connected to opposing sidewalls of the container at a position substantially adjacent to the top end of the baffle, the baffle forming a substantially vertical barrier preventing substantial movement of contents of the container past the baffle during dumping and transport when locked in a substantially vertical position by an operator-controlled retention mechanism operatively connected between the baffle and at least one of the opposing sidewalls of the container.

In certain embodiments, the retention mechanism engages the baffle to at least one of the opposing sidewalls at a position substantially adjacent to the bottom end of the baffle.

In certain embodiments, the bottom of the baffle is held above the floor of the container, leaving a gap between the bottom of the baffle and the floor of the container when the baffle is in the substantially vertical position.

In certain embodiments, the retention mechanism is a pin inserted into an outer sidewall opening and extending therethrough into an opening in the baffle, thereby locking the baffle in place in the substantially vertical position.

In certain embodiments, the transport container further comprises an operator-controlled guide mechanism for aligning the outer sidewall opening and the opening in the baffle, to facilitate insertion of the pin.

In certain embodiments, the guide mechanism comprises a rotatable rod extending from the front of the container to the baffle, wherein one end of the rod is attached to a pair of parallel baffle guide arms which engage the baffle at opposite sides from the top end of the baffle.

In certain embodiments, the guide arms have lengths ranging from about one third to about two thirds of the height of the baffle.

In accordance with another embodiment of the invention, there is provided a transport container configured for use with a dump truck tractor trailer, the container comprising: a pivotable lid configured to cover and expose an open top of the container, the open top allowing addition of contents to the container; a pivotable end gate configured to cover and expose an open back end of the container, the open back end allowing dumping of contents of the container; and at least one baffle inside the container, the baffle pivotably connected to opposing sidewalls of the container at an intermediate position between the top end of the baffle and the bottom end of the baffle, the baffle forming a substantially vertical barrier preventing substantial movement of contents of the container past the baffle during dumping and transport when locked in a substantially vertical position by an operator-controlled retention mechanism operatively connected between the baffle and at least one of the opposing sidewalls of the container.

In certain embodiments, the retention mechanism is at least one hydraulic ram operatively connected between at least one of the opposing sidewalls and an upper part of the baffle above the hinge, the hydraulic ram configured to: pivot the baffle away from the substantially vertical position when extending; pivot the baffle toward the substantially vertical position when retracting; and retain the baffle in place when the hydraulic ram is stationary.

In certain embodiments, the bottom of the baffle is held above the floor of the container when in the substantially vertical position, leaving a gap between the bottom of the baffle and the floor of the container.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale. Emphasis is instead placed upon illustrating the principles of various embodiments of the invention. Similar reference numerals indicate similar components.

FIG. 1A is a perspective side view of a transport trailer with an example of a container 3 of the type appropriate for use with embodiments of the invention.

FIG. 1B is another perspective side view of the transport trailer with the container 3 of FIG. 1A.

FIG. 2 is a top perspective view of a container 5 in accordance with a first embodiment of the invention.

FIG. 3 is a perspective view of a baffle alignment system used in the first embodiment of the container 5 which is used to align an opening in at least one of the container sidewalls 23b with an opening in one of the narrow sides of the baffle 20 shown in FIG. 2.

FIG. 4 is a perspective view of a baffle retention pin 25 and sleeve 26 which is used to lock the baffle in a vertical position for prevention of flow of container contents.

FIG. 5 is a partially cut-away side perspective view of the same container embodiment 5 of FIG. 2 showing detail of the baffle alignment system 24 and the baffle retention pin 25.

FIG. 6 is a perspective view of another container embodiment 7 which has a hydraulic ram 52 attached at one end to a cross member 53 and attached at the other end to a position near the top of the baffle 50.

FIG. 7 is a partially cut-away side perspective view of the same embodiment 7 of FIG. 6, showing the hydraulic ram 52 in an extended position which causes the baffle 50 to pivot on its hinge 51 which is located closer to the middle of the baffle 50.

FIG. 8 is a perspective view of a dump truck with a container embodiment 7 according to FIGS. 6 and 7 showing the container 7 in a tipped position relative to its trailer frame 61 as driven by its lifting ram 62 for dumping of drilling waste DW. It is seen that the hydraulic ram 52 has moved the baffle 50 away from its vertical blocking position to allow movement of the drilling waste DW from the front compartment 21 to the rear compartment 22.

### DETAILED DESCRIPTION

### Rationale

Drill cuttings are commonly known as drilling waste, because they serve no purpose after they have been removed from the wellbore. Thus, drill cuttings contaminated with drilling fluid are typically stabilized with a bulking agent, such as fly-ash, sawdust, or liquid absorbing pellets, to prevent residual free liquids from leaching from the solids during transport. The drilling waste is then typically transported to a secure landfill for storage for an indeterminate period of time, typically generations.

With the evolution of new technologies and the increasing cost of drilling fluids, efforts to reclaim drilling fluids from drill cuttings are increasing. However, technologies such as thermal extraction, solvent washes, or alternate mechanical separators work less effectively, if at all, with bulking agents added prior to shipping.

If stabilization materials are not added to the slurry of drill cuttings and drilling fluid, the drilling fluid and other fluids may leach from the slurry. This is unacceptable both during transport and at any landfill, or during the unloading process at a waste treatment facility. Such unstabilized drilling waste also typically moves and behaves more like a liquid within the container of a transport vessel due to the presence of significant volumes of oil, water or other liquids, which may be as high as 20% to 50% of the total volume of the drilling waste.

To solve the problem of a slurry/sludge sloshing around and/or accumulating at one end of the container during transport, the slurry/sludge may be mixed with another material for stabilization. At oil and gas sites, sawdust is often mixed with a slurry of drill cuttings to stabilize the drill cuttings for transport. However this results in increased costs and time due to additional steps, additional materials, additional labor, and an increased volume of material to transport. Furthermore, if the slurry is to be transported to a site for separation and recovery of the slurry components, the addition of a further component complicates the separation process and creates further waste material.

Oil and gas well drillers have come under increased scrutiny to better manage or recycle waste streams and thus, the services sector has responded to meet the growing need of drilling waste treatment. With the advent of new treatment technologies such as mechanical separation, thermal extraction and solvent washing, there is greater access to waste treatment facilities throughout North America. Hence the need for more efficient and effect means of transporting unstabilized drilling waste.

Tankers and containers may be insulated to help prevent the contents from freezing in cold temperatures, which makes it difficult to unload the contents from the tank/container. A drawback with insulation is that it adds extra bulk and weight to the tank/container, which can reduce the volume and weight of material that can be transported in a load. While the insulation may be useful when temperatures are near or below freezing, tanks/containers are often used in locations with seasonal variation, and the insulation adds unnecessary weight/bulk during the warmer months.

Accordingly, there is a need for an economical transport trailer having a container for transporting a sludge/slurry such as drilling waste that is easy to unload and unload, and wherein the sludge/slurry is stabilized by the structural and functional features of the container without a need to add further materials to the sludge/slurry for stabilization. There is also a need for a transport trailer container that can be cleaned easily and that prevents the contents from freezing or sticking to the inside of the container in cold temperatures.

As noted above commonly owned U.S. Pat. No. 9,061,623, incorporated herein by reference in its entirety, describes a sealable transport trailer container with a series of linked hinged baffles for transporting unstabilized drill cuttings which are highly fluidic in nature. In this container the linkage between the end gate and the baffles ensures that all baffles pivot simultaneously with pivoting of the end gate to allow dumping of the container contents. Testing of this container led to the discovery that that, while it prohibited movement of unstabilized drill cuttings during transport, the interconnected baffle system made the transport container unpractical for movement of other materials, such as dry drilling waste or other dry solids due to the fact that dry materials would become compacted by road vibration. The resulting agitation caused the dry material to settle and pack around the interconnected baffle system thereby effectively holding the interconnected baffles in place and prohibiting the end gate from opening. It was found that the baffle system had to be removed from the transport container to accommodate materials other than wastes that were at least partially fluidic in nature.

The container embodiments described herein were developed to address these problems, which are common to transport of slurry-like materials and particularly to wet fluidic drilling waste which does not contain added materials for stabilization such as sawdust.

### Introduction

Various aspects of the invention will now be described with reference to the figures. For the purposes of illustration, components depicted in the figures are not necessarily drawn to scale in all cases. Instead, emphasis is placed on highlighting the contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

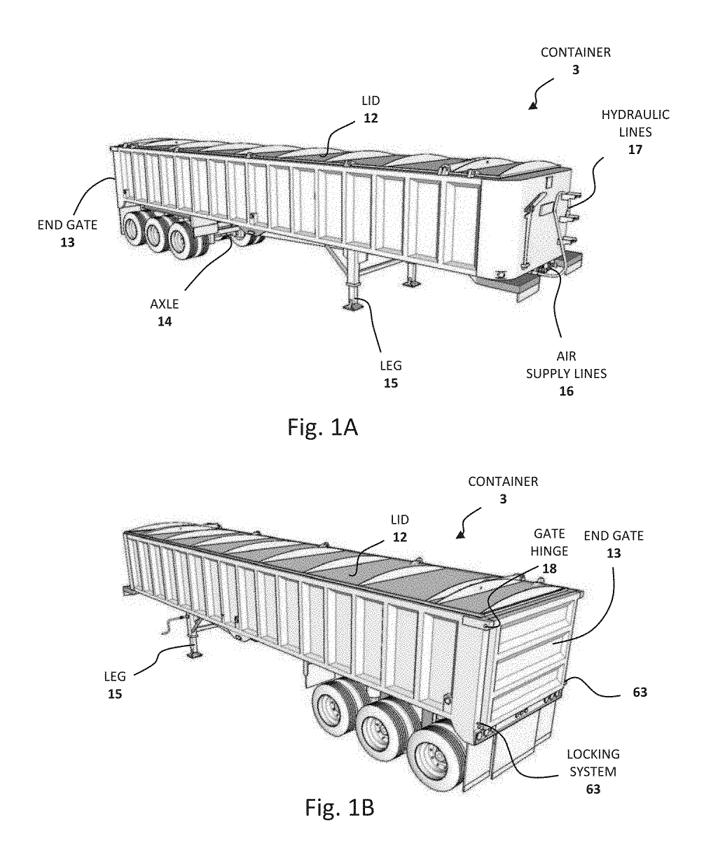

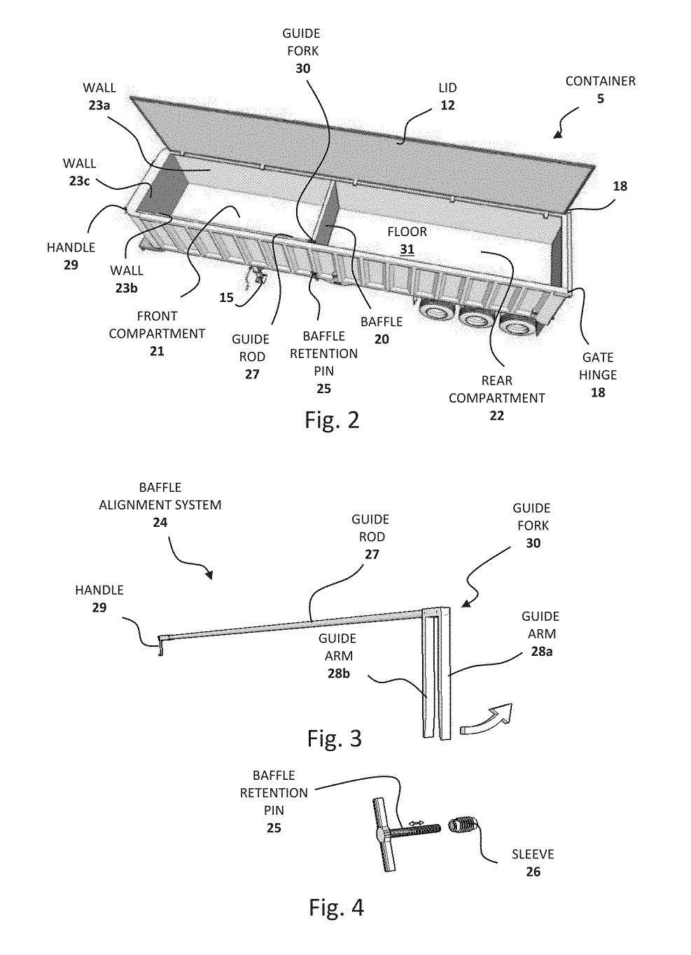

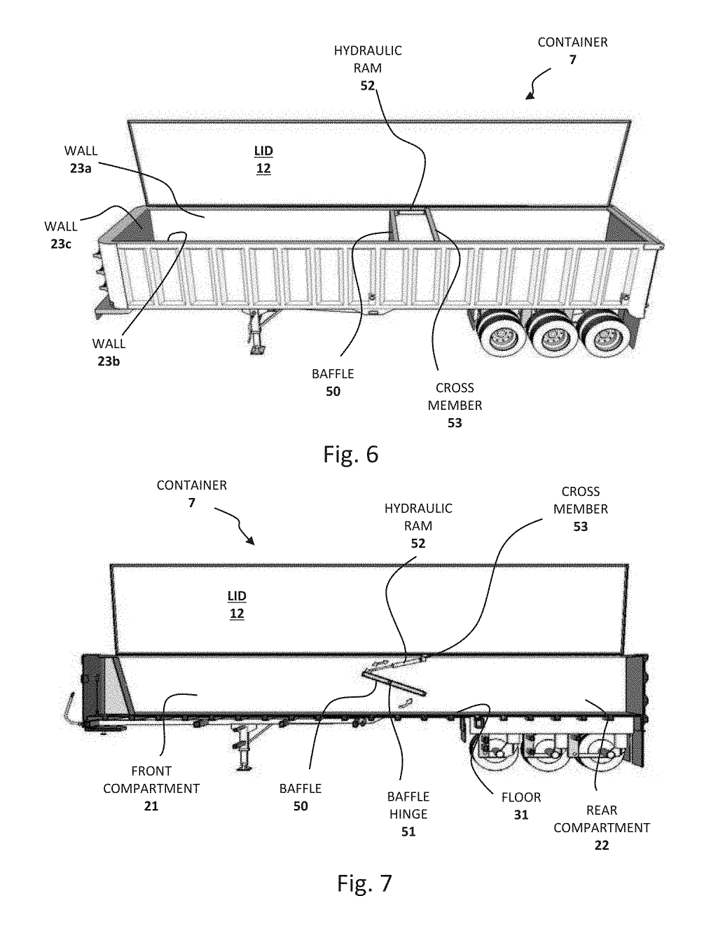

Shown in FIG. 1A and 1B are views of a representative end-dump transport trailer container 3 with characteristics suitable for use with embodiments of the present invention which are described with respect to the subsequent figures (a first container embodiment 5 is shown in FIGS. 2 to 5 and a second embodiment 7 is shown in FIGS. 6 to 8). The container embodiments 3, 5 and 7 each have a hinged lid 12 which can be opened for loading of container contents (as seen, for example in FIGS. 2 and 5-7 and closed during transport to prevent spillage. The container embodiments 3, 5 and 7 also have an end gate 13 which pivots on a gate hinge 18 to allow dumping of contents. In these embodiments, the end gate 13 is pivotably connected to the rear end of the container 3 via end gate hinges 18. A bottom end of the end gate 13 swings outwardly to allow the contents in the container 3 to flow out the rear end of the container. The end gate 13 includes seals (not shown) located between the inside surface of the end gate 13 and the container walls 23a, 23b for creating a tight seal and preventing any contents from leaking out of the container 3 when the end gate 13 is closed and locked.

In some embodiments, the pivoting of the end gate 13 may be controlled using a hydraulic ram (not shown). A conventional locking mechanism 63 is used to lock the end gate 13 in its closed position. The locking mechanism 63 may be automatically or manually controlled. The end gate 13 may also be provided with a pressure release valve (not shown) that can be opened to equalize the pressure inside the container 3 and outside the container 3.

As seen in FIG. 1A, container 3 is equipped with additional equipment including conventional connection points to a trailer having conventional axles 14 legs 15, and ancillary equipment such as air supply lines 16 and hydraulic lines 17, for example.

In both of the illustrated container embodiments 5 and 7, there is shown a single hinged baffle which operates independently of any other hinge mechanism associated with any other structural component of the container. For example, alternative embodiments (not shown) may include one or more additional hinged baffles, the hinges of which operate independently of each other and independently of the illustrated end gate hinge 18.

The baffle hinge of container embodiments 5 and 7 is a conventional axle-type hinge which is passed through a cylindrical opening in the baffle and which extends into opposed openings in opposed inner sidewalls 23a, 23b of the container 5 and 7. The axle remains stationary while the sidewall of the cylindrical opening in the baffle rotates around the axle as the baffle pivots on the hinge. Alternative hinging mechanisms are possible and are used alternative embodiments.

In both of the illustrated embodiments, the single baffle 20 (embodiment 1) or 50 (embodiment 2) divides the interior of both embodiments of the container 5, 7 into a front storage compartment 21 and a rear storage compartment 22. The front compartment 21 is formed by the opposed inner sidewalls 23a, 23b, front inner sidewall 23c, the front side of the baffle 20 and the container floor 31. Likewise, the rear compartment 22 is formed by the opposed inner sidewalls 23a, 23b, the rear side of the baffle 20 or 50 and the inner sidewall of the end gate 13. It is to be understood that alternative embodiments with more than one baffle with similar hinging mechanisms will divide the container into more than two storage compartments (not shown). In these embodiments, the independent operation of individual baffles is substantially identical.

One exemplary embodiment of an existing container that can be adapted for integration with the components described herein to produce various embodiments of the invention is a container with sidewalls which are generally vertical and parallel to one another. In one example, this container is approximately 13 meters long and 2.5 meters wide, creating an internal volume of approximately 28 m³. Preferably, the internal volume of the container is approximately 22 m³ to 28 m³, although various other sizes of a container could be used as would be known to one skilled in the art. The walls and floor of the container are preferably made of a strong durable and chemically resistant material such as steel.

### Embodiment 1: Container with Free-Pivoting Baffle and Baffle Retention Mechanism

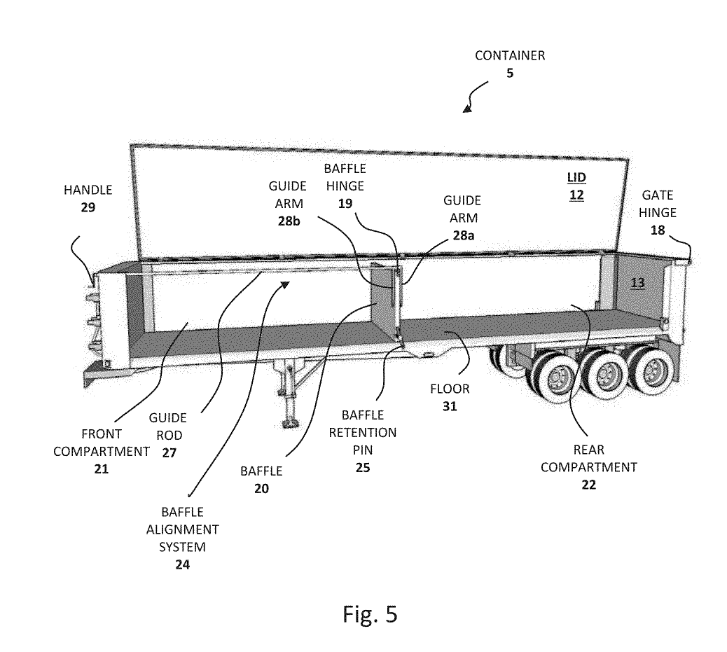

In accordance with a first embodiment of the invention, there is shown in FIGS. 2 and 5, a container 5 provided with a free-pivoting baffle 20. The baffle 20 is generally rectangular in shape as shown and is formed of relatively strong material such as steel and has sufficient thickness to act as a barrier to flow of an industrial slurry such as drilling waste, for example. In this embodiment, it is to be understood that the baffle 20 is configured to freely pivot on its hinge 19 which is best visualized in the cut-away view of FIG. 5. As such, the baffle 20 will remain in a substantially vertical position hanging from its hinge 19 when the container 5 is being tipped for dumping of its contents because the baffle 20 is dimensioned such that a gap is provided between the bottom of the baffle 20 and the floor 31 of the container to allow the floor 31 to be tilted while the baffle 20 remains hanging in its normal substantially vertical position, as influenced simply by its center of gravity. It is to be understood that the absence of such a gap would cause the baffle 20 to be in contact with the floor 31 and as such, the frictional contact of the bottom edge of the baffle 20 with the floor 31 would in most cases cause the baffle 20 to tilt together with the floor 31 and prevent the desired function of opening a space for transfer of container contents from the front compartment 21 to the rear compartment 22. In preferred embodiments, the gap between the bottom edge of the baffle 20 and the floor 31 is at least greater than about 1 cm. This gap will allow tilting of the floor 31 with respect to the baffle 20 which remains vertical, when the container 5 is tipped for dumping of contents. This gap will allow some relatively minor flow volume of the contents of the container 5 between the front 21 and rear 22 storage compartments when the baffle 20 is locked in the vertical position as described hereinbelow. Such minor flow will not impede the desired effect of prevention of movement of the center of gravity of the container 5 and its contents during transport.

This embodiment of the container 5 is provided with a baffle alignment system 24 which allows the baffle 20 to be pivotally moved by an operator so that it can be properly aligned with a retention mechanism for locking the baffle 20 in place in its vertical blocking position. This locked arrangement prevents the aforementioned free-pivoting motion (or swinging) of the baffle 20. The baffle alignment system 24 is particularly helpful in solving the problem of free-pivoting motion of the baffle 20 being impeded when contents of the container 5 become packed around the baffle 20. The guide system 24 allows the baffle 20 to be pivoted slightly to dislodge the packed contents.

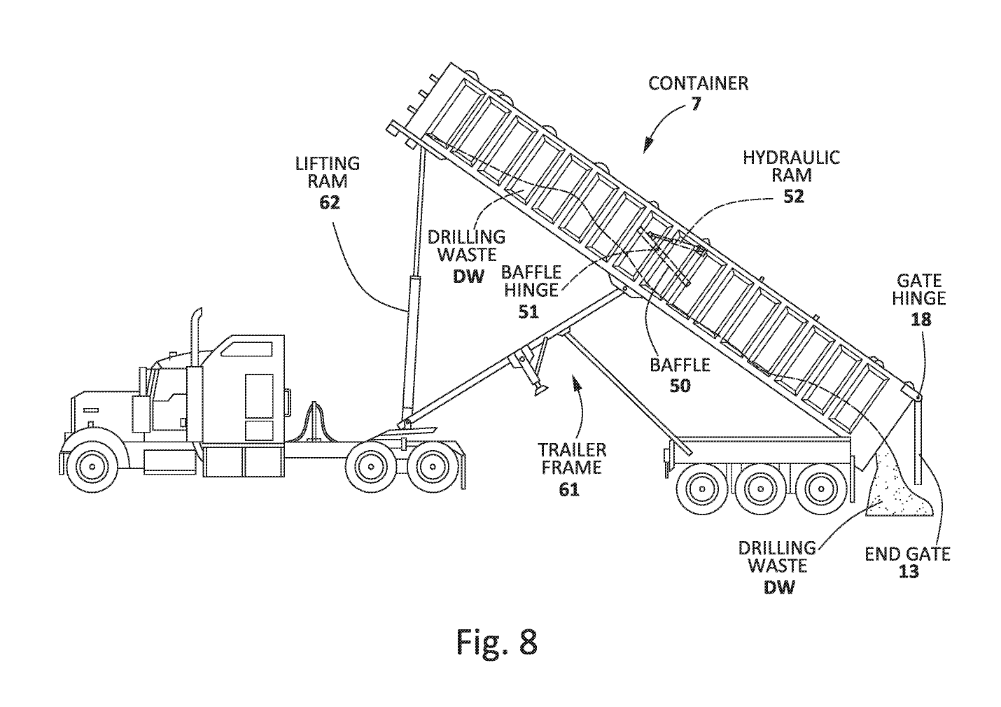

The features of the baffle alignment system 24 are best visualized in FIG. 3 where it is seen that the system 24 includes a guide rod 27 with a guide fork 30 having a pair of guide arms 28a, 28b attached to its right end (in the orientation shown) and a handle 29 attached to its left end (in the orientation shown). During operation of the baffle alignment system 24, the handle 29 is moved rotate the guide rod 27 which is secured to the inside of the container with a loose clamping mechanism (not shown) which allows axial rotation of the guide rod 27. It is seen in FIG. 5 that the handle 29 extends out of the container 5 at its front end. Rotation of the guide fork 30 by about 90 degrees causes the guide arms 28a, 28b to move between an upper substantially horizontal position and a lower substantially vertical position. When in the lower position, the guide arms 28a, 28b reside on opposite sides of the baffle 20 where they hold the baffle 20 in position to allow alignment of an opening in an outer sidewall of the container 5 with a corresponding opening in a lower portion of the narrow end of the baffle 20. In this particular embodiment, the alignment of the two openings allows for insertion of a pin engagement mechanism. While there are many possible locking pin arrangements, the illustrated embodiment in FIG. 4 provides a threaded baffle retention pin 25 which engages mating threads within the container wall until the pin 25 emerges through the container sidewall 23b and protrudes into a receiving threaded sleeve 26 integrated into the side edge of the lower end of the baffle 20 which is parallel with and in close proximity to the container sidewall 23b. If the contents of the container are unstabilized drilling waste, there would be minimal threat of liquids entering between the threads of due to the viscous nature of the unstabilized drilling waste. However, if such leakage is a concern, a thread leak protectant is added to prevent such leakage. Advantageously, the pin 25 is provided with a handle to facilitate this threading engagement, as illustrated. In this locked position, contents of the container 5 are substantially prevented from moving from the front compartment 21 to the back compartment 22 and vice versa, during transport of the container. This prevents shifting of the center of gravity of the container 5 and improves the handling of the transport vehicle. If it is desirable to allow the baffle 20 to swing freely (during tipping, for example), the baffle retention pin 25 is disengaged from the baffle 20 and the handle 29 is used to rotate the guide rod 27 until the guide arms 28a, 28b attain their upper position above the top of the baffle 20 where they do not interfere with pivoting motion of the baffle 20. In this position, the baffle 20 is allowed to freely pivot on its hinge 19 and when the container 5 is tipped, its contents (such as drilling waste DW, as shown in FIG. 8) can flow past the baffle 20 (i.e. flow from the front compartment 21 to the rear compartment 22) to facilitate dumping of the container contents).

The guide arms 28a, 28b of the guide fork 30 should be of sufficient length to effectively act as levers to move the baffle 20 for the alignment of the openings in the container sidewall and the baffle. In certain embodiments, the guide arms 28a, 28b each have similar lengths of about ⅓ to about ⅔ of the total height of the baffle 20.

To accommodate the guide arms 28a, 28b when they are in the upper horizontal position, there is an upper gap between the top edge of the baffle 20 and the top of the container 5 (as defined by a horizontal plane at the tops of the opposed sidewalls 23a, 23b of the container 5). As such, the guide arms 28a, 28b do not block closure of the lid 12 and do not interfere with pivoting of the baffle 20 when they reside within this gap in the upper horizontal position. In certain embodiments, the upper gap is defined by a space extending by at least about 10 cm from the top edge of the baffle 20 to the top of the container 5.

Certain embodiments of the baffle alignment system 24 are configured with one or more limits on rotation of the guide rod 27 so that the guide rod cannot be rotated to move the guide fork 30 past its upper horizontal position above the top edge of the baffle 20. This prevents the possibility of the guide fork 30 attaining a position where it would interfere with closure of the lid 12.

In certain embodiments, the guide arms 28a, 28b are constructed of relatively light materials because their primary function is to guide vertical placement of the baffle 20 for alignment of the retention system and not to move the baffle through a wide range of motion.

In alternative container embodiments equipped with more than one baffle (not shown), the guide system 24 is modified to guide each baffle either independently or in a manner where all baffles are simultaneously guided to align their individual retention mechanisms. For independent guide systems (not shown), a separate guide rod and fork is provided for each baffle and the lengths of the guide rods vary according to the location of the individual baffle it guides in the container. In this alternative embodiment, the separate guide rods are placed adjacent to the sidewalls. For example, in a container having two baffles, a first baffle is guided by a system with a guide rod placed adjacent to the top of one of the side walls and a second baffle is guided by a separate guide rod placed adjacent to the opposite sidewall. This arrangement keeps the guide rods from interfering with efficient loading of the container via its open top. For simultaneous guiding of multiple baffles, the same rod extends across the top of each one of the baffles and has individual guide forks attached thereto, in order to simultaneously guide each of the individual baffles by rotation of the single guide rod.

### Operation of Embodiment 1

During typical operation of the container 5, it is mounted on a transport trailer, for example, as shown in FIGS. 2 and 5. The trailer may be attached to a dump-truck style vehicle at this point or attached later after loading. The baffle 20 is locked in place using the baffle retention pin 25 to create front and rear compartments 21 and 22, the lid 12 is opened and the end gate 13 is closed and locked. Unstabilized drilling waste is loaded into the container 5 using an auger, hose, loader or excavator, or other similar transfer equipment to evenly distribute the drilling waste between the compartments. The lid 12 is then closed, locked and sealed. In some embodiments, a conventional hydraulic ram system (not shown) is used to seal the lid 12. The container 5 is then transported to a drilling waste treatment facility. During transport, the baffle 20 remains locked in the vertical position, keeping the load contents compartmentalized and preventing them from sloshing between the front and rear ends of the container and/or accumulating at one end of the container. If the external temperature is near or below freezing, an optional heater system is activated to prevent freezing of the container contents.

Upon arrival at the treatment facility, the container 5 is positioned for dumping the load from the rear end of the container 5. If in use, the heater system is turned off. A pressure release valve on the end gate 13 is opened to release any built up pressure inside the container. It would be most common for the drilling waste to originate from a drilling operation and thus, both compartments 21, 22 are to be unloaded into a single receiving tank at the facility. Thus, the baffle retention pin 25 is disengaged and the guide rod 27 of the baffle alignment system 24 is rotated to bring the guide fork 30 to its horizontal position above the top edge of the baffle, thereby preventing the guide fork 30 from interfering with pivoting of the baffle upon its upper hinge 19. The front end of the container 5 is moved upwardly to angle the container with the rear end of the container lower than the front end of the container (this process is known as “tipping the container”). The baffle 20 now freely pivots and continues to hang vertically from its hinge as the floor 31 of the container is tipped. A substantial gap opens between the floor 31 of the container and the bottom edge of the baffle 20. The end gate 13 is unlocked and opened allowing the drilling waste from all compartments to flow out from the rear end of the container 5. After emptying the drilling waste, if the container 5 is equipped with optional cleaning jets, they are activated to clean out any debris left in the container from the load. The container 5 is then returned to the substantially horizontal position thereby allowing the end gate to close and allowing the end gate locking mechanism to be reactivated. The baffle 20, which is now naturally hanging in the vertical position, is then guided using the baffle alignment system 24 to align it properly for insertion of the baffle retention pin 25 into its corresponding sleeve 26 by rotating the guide rod 27 using the handle 29. When the pin 25 is inserted into the sleeve 26, the baffle 20 is locked in place and the container 5 is ready to return to the drilling site to accept another load of drilling waste.

In another possible mode of operation of container 5, the drilling waste in the rear compartment 22 may be unloaded first without unloading of the drilling waste from the front compartment 21 if the baffle retention pin 25 remains inserted into its corresponding sleeve 26 inside the baffle 20. This would allow for separate dumping of drilling waste from the two compartments at separate locations if desired. In this case, the skilled person will recognize that the process would be repeated for each additional baffle included in alternative embodiments until all compartments are emptied of drilling waste.

### Embodiment 2: Hydraulically-Driven Pivoting Baffle System

A second container embodiment 7 is illustrated in FIGS. 6 to 8. In this embodiment, the general features of the container 7 including the sidewalls 23a, 23b and front wall 23c, floor 31, lid 12, and end gate 13 are similar to those of embodiment 1 (container 5). The baffle 50 of container 7 is of similar construction as that of the baffle 20 of embodiment 1 (container 5) with the only exception being the position of its hinge 51 which is located at a position closer to or at the middle of the side edge of the baffle 51, as best seen in FIG. 7. The hinge 51 is joined to the opposing side walls 23a, 23b of the container 7 using an axle-type hinge as described above for container embodiment 5. As such, pivoting motion of the baffle 50 will cause its top and bottom ends to move in opposite directions, as illustrated in FIGS. 7 and 8, which will be described in more detail hereinbelow.

This embodiment of the container 7 has a hydraulic ram 52 connected between a position at or near the top of the baffle 50 and a cross member 53 extending between the opposed side walls 23a, 23b of the container 7. A possible variation of this embodiment has a connection directly to one of the side walls 23a or 23b without the presence of a cross member.

The hydraulic ram 52 is provided with a conventional control mechanism which allows it to be remotely controlled by an operator. In a comparison of FIGS. 6 and 7, it can be seen that when the hydraulic ram 52 is completely retracted, the baffle 50 is retained in the substantially vertical blocking position. When the hydraulic ram 52 is extended, its front end (in the orientation shown) pushes against an upper part of the baffle 50, causing it to pivot on its hinge 51, thereby opening a gap between the bottom edge of the baffle 50 and the floor 31 of the container 7. The size of the gap is controllable by the extent of extension of the hydraulic ram 52. The gap allows the contents of the container to slide from the front compartment 21 to the rear compartment 22 when the container is tipped. In contrast, when the hydraulic ram 52 is retracted from its extended position, the baffle 50 is pulled back to its substantially vertical blocking position which generally prevents flow of the container contents from the front compartment to the rear compartment, as would be desirable during transport, as described above. As such, the hydraulic ram 52 serves as the baffle retention system in this embodiment when it is stationary (i.e. not extending or retracting).

In certain alternative embodiments based on embodiment 2, an additional hydraulic ram is provided at the opposite side of the baffle 50 to improve balance of stresses on the baffle.

One advantage of embodiment 2 over embodiment 1 is that the hydraulic ram 52 applies force to the baffle to move it from a closed position to an open position. As mentioned above, the transport of dry materials coupled with the vibration of the container 7 in transit can cause the dry materials to settle and pack, effectively cementing mechanical components in place. The force applied by the hydraulic ram 52 can force the baffle 50 to fracture the compacted contents thereby reducing the possibility of the solids remaining in the container 7 when the container 7 is moved to an open, tipped position.

### Operation of Embodiment 2

The operation of this second embodiment of the container 7 is generally similar to the operation of embodiment 1 with the exception that a guide system is not necessary because all movement and alignment of the baffle 50 is controlled by its connected hydraulic ram 52 which causes the baffle 50 to pivot on its hinge 51. As such, the baffle 50 may be either locked in the vertical position (wherein the hydraulic 52 ram remains stationary) during dumping of contents of the rear compartment 22 without dumping of contents of the front compartment 21, or may be in an extended position with a gap between the floor 31 of the container 7 and the bottom edge of the baffle 50 to allow contents of the front compartment 21 to slide into the rear compartment 22 and out of the container as shown in FIG. 8 where it is seen that the lifting ram 62 raises the front end of the container 7 to tip it with corresponding pivoting of the front end of the trailer frame 61.

### Additional Embodiments and Features

Commonly owned U.S. Pat. No. 9,061,623 (incorporated herein by reference in its entirety) describes a container lid which is suitable for use with embodiments of the present invention. This reference also describes an independent heating and cleaning system that can be used to prevent the contents in the container from freezing during cold temperatures and after unloading is complete. This cleaning system can be employed to flush residual materials from the container. However it is to be understood that the cleaning system is optional because the compartments of the container embodiments are substantially open when the lid is open and this allows other external cleaning equipment to be used to clean the container.

In some alternative embodiments, each baffle has one or more openings to allow controlled transfer among compartments, thereby allowing slow movement of the container contents for even distribution during transport.

### EQUIVALENTS AND SCOPE

Other than described herein, or unless otherwise expressly specified, all of the numerical ranges, amounts, values and percentages, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used).

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art to which this invention belongs.

While this invention has been particularly shown and described with references to embodiments thereof, it will be understood by those skilled in the art that various changes in form and details may be made therein without departing from the scope of the invention encompassed by the appended claims.

1. A transport container configured for use with a dump truck tractor trailer, the container comprising:
a) a pivotable lid configured to cover and expose an open top of the container, the open top allowing addition of contents to the container;
b) a pivotable end gate configured to cover and expose an open back end of the container, the open back end allowing dumping of the contents; and
c) at least one baffle inside the container, the baffle pivotably connected to opposing sidewalls of the container and forming a substantially vertical barrier preventing substantial movement of the contents past the baffle during dumping and transport when locked in a substantially vertical position by an operator-controlled retention mechanism operatively connected between the baffle and at least one of the opposing sidewalls of the container.

2. The transport container of claim 1, wherein the retention mechanism operatively engages the baffle to at least one of the opposing sidewalls.

3. The transport container of claim 2, wherein the bottom of the baffle is held above the floor of the container when in the substantially vertical position, leaving a gap between the bottom of the baffle and the floor of the container.

4. The transport container of claim 3, wherein the baffle is hinged to the opposing sidewalls at a position substantially adjacent to the top end of the baffle.

5. The transport container of claim 4, wherein the retention mechanism is a pin inserted into an outer sidewall opening and extending therethrough into an opening in the baffle, thereby locking the baffle in place in the substantially vertical position.

6. The transport container of claim 5, further comprising an operator-controlled guide mechanism for aligning the outer sidewall opening and the opening in the baffle, to facilitate insertion of the pin.

7. The transport container of claim 6, wherein the guide mechanism comprises a rotatable rod extending from the front of the container to the baffle, wherein one end of the rod is attached to a pair of parallel baffle guide arms which engage the baffle at opposite sides from the top end of the baffle.

8. The transport container of claim 7, wherein the guide arms have lengths ranging from about one third to about two thirds of the height of the baffle.

9. The transport container of claim 2, wherein the baffle is hinged to the opposing sidewalls at an intermediate position between the top of the baffle and the bottom of the baffle.

10. The transport container of claim 8, wherein the retention mechanism is a hydraulic ram operatively connected between at least one of the opposing sidewalls and an upper part of the baffle above the hinge, the hydraulic ram configured to:
i) pivot the baffle away from the substantially vertical position when the hydraulic ram is extending;
ii) pivot the baffle toward the substantially vertical position when the hydraulic ram is retracting; and
iii) retain the baffle in place when the hydraulic ram is stationary.

11. A transport container configured for use with a dump truck tractor trailer, the container comprising:
a) a pivotable lid configured to cover and expose an open top of the container, the open top allowing addition of contents to the container;
b) a pivotable end gate configured to cover and expose an open back end of the container, the open back end allowing dumping of contents of the container; and
c) at least one baffle inside the container, the baffle pivotably connected to opposing sidewalls of the container at a position substantially adjacent to the top end of the baffle, the baffle forming a substantially vertical barrier preventing substantial movement of contents of the container past the baffle during dumping and transport when locked in a substantially vertical position by an operator-controlled retention mechanism operatively connected between the baffle and at least one of the opposing sidewalls of the container.

12. The transport container of claim 11, wherein the retention mechanism engages the baffle to at least one of the opposing sidewalls at a position substantially adjacent to the bottom end of the baffle.

13. The transport container of claim 12, wherein the bottom of the baffle is held above the floor of the container, leaving a gap between the bottom of the baffle and the floor of the container when the baffle is in the substantially vertical position.

14. The transport container of claim 12, wherein the retention mechanism is a pin inserted into an outer sidewall opening and extending therethrough into an opening in the baffle, thereby locking the baffle in place in the substantially vertical position.

15. The transport container of claim 14, further comprising an operator-controlled guide mechanism for aligning the outer sidewall opening and the opening in the baffle, to facilitate insertion of the pin.

16. The transport container of claim 15, wherein the guide mechanism comprises a rotatable rod extending from the front of the container to the baffle, wherein one end of the rod is attached to a pair of parallel baffle guide arms which engage the baffle at opposite sides from the top end of the baffle.

17. The transport container of claim 16, wherein the guide arms have lengths ranging from about one third to about two thirds of the height of the baffle.

18. A transport container configured for use with a dump truck tractor trailer, the container comprising:
a) a pivotable lid configured to cover and expose an open top of the container, the open top allowing addition of contents to the container;
b) a pivotable end gate configured to cover and expose an open back end of the container, the open back end allowing dumping of contents of the container; and
c) at least one baffle inside the container, the baffle pivotably connected to opposing sidewalls of the container at an intermediate position between the top end of the baffle and the bottom end of the baffle, the baffle forming a substantially vertical barrier preventing substantial movement of contents of the container past the baffle during dumping and transport when locked in a substantially vertical position by an operator-controlled retention mechanism operatively connected between the baffle and at least one of the opposing sidewalls of the container.

19. The transport container of claim 18, wherein the retention mechanism is at least one hydraulic ram operatively connected between at least one of the opposing sidewalls and an upper part of the baffle above the hinge, the hydraulic ram configured to
i) pivot the baffle away from the substantially vertical position when extending;
ii) pivot the baffle toward the substantially vertical position when retracting; and
iii) retain the baffle in place when the hydraulic ram is stationary.

20. The transport container of claim 19, wherein the bottom of the baffle is held above the floor of the container when in the substantially vertical position, leaving a gap between the bottom of the baffle and the floor of the container.
